(19) United States
(12) Patent Application Publication
(10) Pub. No.: US 2012/0018255 A1
(43) Pub. Date: Jan. 26, 2012

(54) AUTOMOTIVE LIFT WITH SECONDARY SAFETY STOP

(76) Inventor: Larry Gross, Warren, OH (US)

(21) Appl. No.: 13/178,956

(22) Filed: Jul. 8, 2011

Related U.S. Application Data
(60) Provisional application No. 61/366,665, filed on Jul. 22, 2010.

(51) Int. Cl. B66F 7/28

(52) U.S. Cl. 187/207; 187/203; 187/210

(57) ABSTRACT

An automotive lift typically includes a plurality of posts, a lift platform and a cable system for raising the lift platform. Various components including sliders slidably mounted on the posts are external to the posts, which facilitates visual inspection and repair of these components and provides for stronger posts. The configuration of the lift also allows the lift to sit on a floor without fasteners such as anchor bolts extending into the floor.

### CROSS REFERENCE TO RELATED APPLICATIONS

This application claims priority from U.S. Provisional Application Ser. No. 61/366,665 filed Jul. 22, 2010; the disclosure of which is incorporated herein by reference.

### BACKGROUND OF THE INVENTION

1. Technical Field

The present invention is generally related to a lift for the raising and lowering of automobiles or the like. More particularly, the invention relates to such a lift which includes vertical posts and a cable system with primary and secondary safety stops. Specifically, the invention relates to such a lift which uses collars which slide externally on the vertical posts.

2. Background Information

Various types of automotive lifts are well known in the art. Amongst these are 2-post lifts and 4-post lifts which utilize a cable system for raising and lowering the lift and include primary and secondary safety stops wherein the primary safety stop typically secures the lift during normal operation and the secondary safety stop secures the lift should the cable break during operation. Although such lifts serve their purpose, one of the drawbacks is related to the configuration of the vertical posts and the interconnection between the posts and the lift platform. More particularly, such posts have a generally U-shaped cross-sectional configuration such that each post defines a vertical channel which is open on one side and receives therein a portion of the lift platform, including a vertical section of the cable and at least a portion of one of the pulleys of the cable system. The primary and secondary safety stops are also received within this channel along with various related components. In some cases, a separate ladder or plate of steel having vertically spaced holes formed therein must be inserted into the channel during installation in order to provide the support ledges on which the primary or secondary safety stops rest when they are positioned to secure the lift platform at a given height. In other cases, ledges or plates are welded within the channel to provide such support ledges. The location of the various components within the channel of the post makes it relatively difficult to install and/or repair these components. In addition, visual inspection of these internal components can be difficult, thereby presenting a safety hazard with respect to inadequate visual safety inspections. Furthermore, the open-sided posts of such lifts present issues concerning structural integrity. Prior art lifts are anchored to a floor using anchor bolts or similar fasteners to ensure stability of the posts. Such anchoring thus requires additional assembly time and prevents the lift from being easily moved from one place to another. In addition, drilling holes in the floor for such anchor bolts is particularly not desirable in some situations. Thus, there is a need for a lift which overcomes these and other drawbacks in the art.

### BRIEF SUMMARY OF THE INVENTION

The present invention provides a lift comprising: a first post having an outer surface; a second post; a lift platform mounted on and movable upwardly and downwardly relative to the posts and adapted to carry a motor vehicle thereon; the lift platform comprising first and second sliders mounted respectively on the first and second posts; a cable assembly which facilitates raising the lift platform; and an engagement between the first slider and the outer surface of the first post during upward and downward movement of the lift platform.

The present invention also provides a lift comprising: a first post; a second post; a lift platform mounted on and movable upwardly and downwardly relative to the posts and adapted to carry a motor vehicle thereon; a cable assembly which facilitates raising the lift platform; and a first cable of the cable assembly having a vertical segment adjacent and entirely external to the first post.

The present invention further provides a lift comprising: a first post; a second post; a lift platform mounted on and movable upwardly and downwardly relative to the posts and adapted to carry a motor vehicle thereon; a cable assembly which facilitates raising the lift platform; and a locking member mounted adjacent the first post and movable between an engaged position in which the locking member supports the lift platform on the first post and a disengaged position in which the locking member does not support the lift platform on the first post; wherein the locking member is entirely external to the first post in the disengaged position.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a perspective view of the lift of the present invention.

FIG. 2 is a perspective view similar to FIG. 1 with the top portion of one of the runways removed to show the hydraulic actuator and portions of the cable system not visible in FIG. 1.

FIG. 3 is an enlarged perspective view of the encircled portion of FIG. 1.

FIG. 4 is a sectional view taken on line 4-4 of FIG. 3.

FIG. 5 is a sectional view taken from the front showing the lift platform being supported by the cables with the primary and secondary safety stops disengaged.

FIG. 6 is a view similar to FIG. 5 and shows the cable in a slack position representing a broken cable such that the lift platform has fallen from the position shown in FIG. 5 and the secondary safety stop has engaged one of the support ledges of the post.

Similar numbers refer to similar parts throughout the drawings.

### DETAILED DESCRIPTION OF THE INVENTION

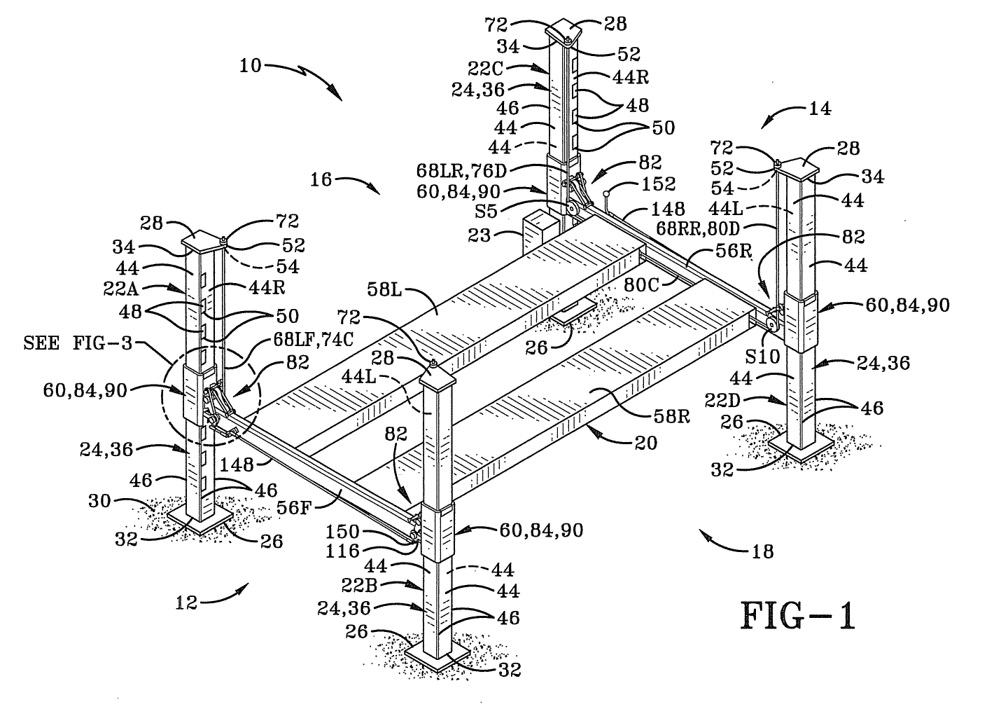

The lift of the present invention is shown generally at 10 in FIG. 1. Lift 10 has front and back ends 12 and 14 defining therebetween a longitudinal direction of the lift, and left and right sides 16 and 18 defining therebetween an axial direction of the lift. Lift 10 includes a rigid lift platform 20 which is mounted on and moveable upwardly and downwardly relative to four rigid vertical post assemblies 22 positioned adjacent the respective corners of platform 20. More particularly, the post assemblies include a front left post assembly 22A, a front right post assembly 22B, a rear left post assembly 22C and a rear right post assembly 22D, each of which is typically formed of metal and is configured to support platform 20 when properly secured to the posts with a motor vehicle seated atop of platform 20. Lift 10 also includes a power drive system for powering the raising and lowering of platform 20 relative to post assemblies 22. The drive system typically utilizes a hydraulic system including a hydraulic pump 23. The drive assembly includes a suitable control mechanism or switch that can be manually operated in order to control the raising and lowering of platform 20. Lift 10 may be configured to support a variety of motor vehicles, such as standard size cars and small trucks or larger vehicles such as buses and the tractors of tractor trailer rigs. Thus, the weight capacity of lift 10 when configured for smaller vehicles is typically somewhere in the range of 8,000 or 9,000 pounds to 11,000 or 12,000 pounds whereas the higher capacity lifts may range up to 20,000, 30,000, 40,000, 50,000 or 60,000 pounds or more.

Post assemblies 22 are now described in greater detail. Each post assembly 22 is either identical or a mirror image of the others. Each assembly 22 includes a rigid vertical post 24, a rigid flat horizontal bottom flange 26 which is rigidly secured to the bottom of post 24 and extends laterally outwardly therefrom beyond the outer surface of the post in all directions, and a rigid horizontal flat top flange 28 which is rigidly secured to the top of post 24 and extends horizontally outwardly therefrom. Each of post 24, flange 26 and flange 28 is formed of metal, typically steel. Due to the configuration of lift platform 20 and post assemblies 22, each post assembly 22 may simply be seated atop a substantially horizontal upper surface of a floor 30 without otherwise securing the post assembly to floor 30, such as with fasteners extending downwardly from the bottom of bottom flange 28, which serves as the bottom of assembly 22 and lift 10, and without fasteners or other portions of lift 10 extending downwardly lower than the upper surface of floor 30. Thus, lift 10 may sit on floor 30 without drilling holes in floor 30, which thus prevents damage to floor 30 and is particularly useful to allow lift 10 to be seated on heated floors. Lift 10 is thus configured to allow it to be a free standing lift which does not require any fasteners extending from any portion of the lift to any external structures other than the contact between the bottom of the lift and the substantially horizontal upper surface of a floor. However, each post assembly 22 may be rigidly secured to floor 30 if desired. For instance, through holes (not shown) may be formed in bottom flange 26 for receiving suitable fasteners there through to secure flange 26 to floor 30. Floor 30 is typically made of concrete or another rigid floor structure material well suited for supporting the substantial load of the lift and motor vehicle when seated on platform 20. Bottom and top flanges 26 and 28 are typically secured to post 24 by welding or other means known in the art. In the exemplary embodiment, post 24 is a hollow structure formed of an annular sidewall having a square cross-section. Post 24 has a bottom end 32 rigidly secured to the top of bottom flange 26 and a top end 34 rigidly secured to the bottom of top flange 28. Post 24 is formed of a vertical annular square sidewall 36 having outer and inner surfaces 38 and 40 each extending from bottom end 32 to top end 34 with inner surface 40 defining a vertical or vertically elongated interior chamber 42 extending from the top to the bottom of post 24. In the exemplary embodiment, interior chamber 42 is a void or completely empty space except as described further below. Square sidewall 36 is formed of four flat vertical walls 44 which are rigidly secured to one another respectively at four right angle corners 46.

A plurality of vertically spaced through openings 48 are formed in sidewall 36 extending from outer surface 38 to inner surface 40 whereby openings 48 communicate with interior chamber 42 and the space external to post 24. In the exemplary embodiment, each opening is rectangular as viewed from the side and has a horizontal bottom which serves as a support ledge 50. Openings 48 are vertically equidistant from one another such that support ledges 50 are likewise vertically equidistant or disposed at regular intervals from adjacent bottom end 32 to adjacent top end 34. As shown in FIG. 1, each of the left post assemblies 22A and 22C has a vertical right flat side wall designated 44R in which openings 48 are formed whereas the right post assemblies 22B and 22D have vertical left flat walls 44L in which openings 48 are formed, although not shown in FIG. 1. In the exemplary embodiment, openings 48 are the only openings or holes formed through sidewall 36 in order to maintain the greatest degree of structural integrity and strength of each post 24. Although other openings may be formed in sidewall 36, it is preferred that sidewall 36 is substantially free of such holes other than openings 48. In particular contrast to prior art lift posts, posts 24 are free of a vertical opening extending from inner surface 40 to outer surface 38 and from adjacent top 34 to adjacent bottom 32, such vertical openings typically receiving therein portions of a lift platform such as an end of a crossbar secured to a runway of the platform. Each top flange 28 includes a cable support 52 which is adjacent and spaced laterally outwardly beyond outer surface 38 of sidewall 36 of the respective post. Typically, a through hole 54 is formed through a portion of top flange 28 which extends from its top to its bottom surface and is disposed laterally outwardly from outer surface 38 for receiving therethrough a cable of the cable system.

With continued primary reference to FIG. 1, platform 20 is now described in greater detail. Platform 20 includes rigid front and rear axial crossbars 56F and 56R wherein front crossbar 56F extends from adjacent the left front post to adjacent the right front post and rear crossbar 56R extends from adjacent the left rear post to adjacent the right rear post. It is noted that each of crossbars 56 is completely external to the corresponding posts 24. Thus, the left end of crossbar 56F is adjacent and external to outer surface 38 adjacent right flat wall 44R of the left front post 24 while the right end of crossbar 56F is adjacent and external to outer surface 38 of the left flat wall 44L of the right front post 24. Similarly, the left end of rear crossbar 56R is adjacent and external to outer surface 38 of right flat wall 44R of the left rear post while the right end of crossbar 56R is adjacent and external to outer surface 38 of left flat wall 44L of the right rear post 24. Lift 20 further includes rigid left and right longitudinal runways 58L and 58R which are axially spaced from and parallel to one another and perpendicular to crossbars 56. Crossbars 56 and runways 58 are formed of metal, typically steel. The front end of each runway 58 is rigidly secured to front crossbar 56F, and the rear end of each runway 58 is rigidly secured to rear crossbar 56R. Left runway 58L is configured to receive thereon the left wheels of a motor vehicle while right runway 58R is configured to receive the right wheels of the motor vehicle when positioned on platform 20 in order to be lifted by lift 10. Ramps (not shown) may be secured to the front of runways 58 to facilitate driving the vehicle up onto and off of runways 58. Platform 20 further includes four sliders 60 which respectively slide upwardly and downwardly along posts 44 during the raising and lowering of platform 20 such that there is a sliding engagement between each slider 60 and outer surface 38 of the corresponding post 24. Sliders 60 are respectively rigidly secured to the left and right ends of crossbars 56F and 56R, and are described in greater detail further below. Platform 20 is entirely external to posts 24.

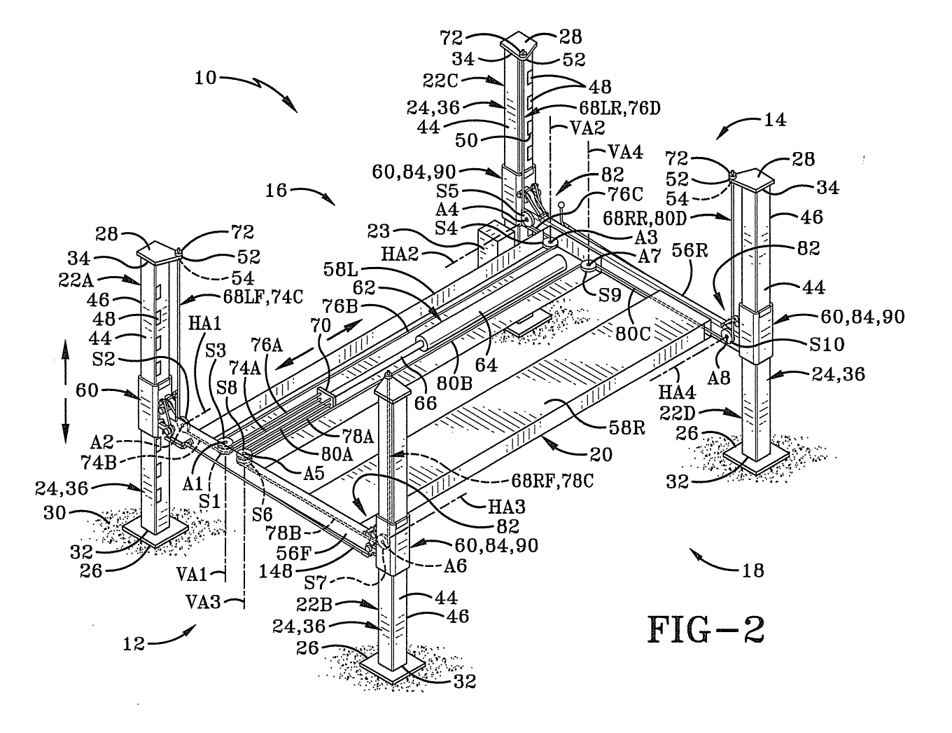

The drive assembly or lift assembly includes a hydraulic linear actuator 62 (FIG. 2) in the form of a piston-cylinder combination having a cylinder 64 and a piston 66 which is hydraulically driven by hydraulic fluid pumped within cylinder 64 by hydraulic pump 23, which is in fluid communication with cylinder 64. The lift mechanism or assembly also includes a cable assembly or system which is operatively connected to and driven by piston 66 and typically includes four flexible metal cables which are associated respectively with each of posts 24 and are entirely external to posts 24. These cables are denoted as a left front cable 68LF, a right front cable 68RF, a left rear cable 68LR and a right rear cable 68RR. Each of cables 68 is securely connected at one end at a respective connection to a cable mounting plate or connector 70 which is rigidly secured to the outer terminal end of piston 66. The other ends of cables 68 extends through the respective holes 54 and are secured to the respective cable support 52 by a respective cable connector 72 which has a larger cross-sectional dimension than cable 68 and is seated atop top flange 28.

The lift system includes the cable assembly, which includes several pulleys and ten sheaves S1-S10, each of which is rotatably secured to lift platform 20. All of sheaves S1-S10 are entirely external to posts 24. More particularly, each of sheaves S1-S10 is rotatably mounted to rotate about a respective axle which is secured to platform 20 such that each sheave is fixed relative to platform 20 other than its rotational motion about the respective axle. Left front cable 68LF engages and is threaded around sheaves S1 and S2. Likewise, left rear cable 68LR engages and is threaded around sheaves S3, S4 and S5; right front cable 68RF engages and is threaded around sheaves S6 and S7; and right rear cable 68RR engages and is threaded around each of sheaves S8, S9 and S10. Sheaves S2, S5, S7 and S10 are all vertically oriented while the remaining sheaves are horizontally oriented. Thus, sheaves S1 and S3 are rotatably mounted on a vertical axle A1 to rotate about a common vertical axis VA1 passing through axle A1; sheave S2 is mounted about a horizontal longitudinal axle A2 and rotates about a longitudinally extending horizontal axis HA1 passing through axle A2; sheave S4 is rotatably mounted on a vertical axle A3 to rotate about a vertical axis VA2 passing through axle A3; sheave S5 is rotatably mounted about a longitudinal horizontal axle A4 to rotate about a longitudinally extending horizontal axle HA2 which is typically coaxial with axis HA1; sheaves S6 and S8 are rotatably mounted on a common vertical axle A5 to rotate about a common vertical axis VA3; sheave S7 is rotatably mounted on a longitudinal horizontal axle A6 to rotate about a horizontal axle H3; sheave S9 is rotatably mounted about a vertical axle A7 to rotate about a vertical axis VA4; and sheave S10 is rotatably mounted about a longitudinal horizontal axle A8 to rotate about a longitudinally extending horizontal axis HA4 which is typically coaxial with axis HA3.

Sheaves S1, S3, S6 and S8 are generally directly forward of actuator 62 and adjacent the front end of runway 58L and front crossbar 56F, typically just a short distance rearward of front crossbar 56F. Sheaves S1 and S3 are generally adjacent and axially spaced from sheaves S6 and S8. Sheave S2 is axially spaced to the left of sheaves S1 and S3 and left runway 58L with axle A2 mounted adjacent the left end of front crossbar 56F to the right of and adjacent slider 60. Sheave S2 and axle A2 are thus adjacent, to the right of and entirely external to the left front post 24. Each of sheaves S4 and S9 are mounted on platform 20 adjacent the rear end of runway 58L and adjacent rear axial crossbar 56R, typically a short distance forward of rear crossbar 56R such that sheaves S4 and S9 are axially spaced from and generally adjacent one another. Sheave S5 is axially spaced to the left of sheave S4 and the rear end of left runway 58L with axle A4 secured to rear crossbar 56R adjacent its left end such that sheave S5 is adjacent said left end, and adjacent and to the right of the left rear slider 60 such that sheave S5 is adjacent, to the right of and entirely external to the left rear post 24 of assembly 22C. Sheave S7 is axially spaced to the right of sheaves S6 and S8 and the front of right runway 58R and mounted via axle A6, which is secured to front crossbar 56F adjacent its right end so that sheave S7 is adjacent and to the left of the right front slider 60 whereby sheave S7 is adjacent, to the left of and entirely external to the right front post 24 of assembly 22B. Sheave S10 is spaced axially to the right of sheave S9 and to the right of right runway 58R adjacent its rear end and is mounted about axle A8, which is secured to rear crossbar 56R adjacent its right end such that sheave S10 is adjacent said right end, and adjacent and to the left of the right rear slider 60, and adjacent, to the left of and entirely external to the right rear post 24 of assembly 22D.

With continued reference to FIG. 2, cable 68LF includes first, second and third cable segments 74A-C. More particularly, first segment 74A is a horizontal longitudinal segment extending from connector 70 forward to sheave S1 and around a portion of the circular outer perimeter thereof. Second segment 74B is a horizontal axial segment extending from sheave S1 to sheave S2 and around a portion of the circular outer perimeter of said sheaves. Segment 74C is a vertical segment extending upwardly from the circular outer perimeter of sheave S2 to the connection with cable support 52 of top flange 28 of support assembly 22A. Second segment 74B is adjacent and forward of front crossbar 56F and is substantially parallel thereto. Segment 74C is parallel to, adjacent and spaced to the right of post 24 of assembly 22A such that segment 74C, support 52 and the connection therebetween are entirely external to the left front post 24 and the left front slider 60. It is noted that cable segment 74B remains at a constant length when cable 68LF is taut during normal operation of lift 10 while segments 74A and 74C will vary in length depending on the height at which platform 20 is set. Thus, the higher that platform 20 is, the longer is first segment 74A and the shorter is third segment 74C. Thus, the retraction of piston 66 lengthens first segment 74A and shortens segment 74C while segment 74B remains constant, thus helping to raise platform 20 in conjunction with the other cables.

Left rear cable 68LR includes first, second, third and fourth cable segments 76A-D. Segment 76A is a horizontal longitudinal segment extending forward from connector 70 to and around a portion of the outer perimeter of sheave S3. Segment 76B is a horizontal longitudinal segment extending from sheave S3 to sheave S4 and around portions of the respective circular outer perimeters thereof. Segment 76C is a horizontal axial segment which extends from sheave S4 to sheave S5 and around portions of the respective circular outer perimeters thereof. Segment 76D is a vertical segment extending from sheave S5 to the connection adjacent the terminal end of the cable with cable support 52 of left rear post assembly 22C. Vertical segment 76D, support 52 and the connection therebetween are thus adjacent, to the right of and completely external to post 24 of assembly 22C. Segment 76D is also to the right of and entirely external to the left rear slider 60, and to the left of the rear end of left runway 58L. When cable 68LR is taut, segments 76B and 76C have a constant length, while the length of segments 76A and 76D vary during the extension and retraction of piston 66 such that the lengthening of segment 76A and the shortening of segment 76D corresponds to the raising of platform 20 while the reverse corresponds to the lowering of platform 20.

Right front cable 68RF includes first, second and third cable segments 78A-C. The first segment 78A extends forward from connector 70 to and around a portion of the circular outer perimeter of sheave S6 and is a horizontal longitudinal segment. Segment 78B is a horizontal axial segment extending from sheave S6 to sheave S7 and around corresponding portions of the circular outer perimeters thereof. Segment 78C is a vertical segment extending around a portion of the circular outer perimeter of sheave S7 and upwardly therefrom to its connection with cable support 52 of post assembly 22B adjacent the terminal end of cable 68RF. Segment 78B is generally parallel to, adjacent and forward of front crossbar 56F. Cable segment 78C is adjacent, to the left of and entirely external to post 24 of assembly 22B and the corresponding right front slider 60. Cable segment 78B maintains a constant length when taut during operation whereas segments 78A and 78C vary in length during the extension and retraction of piston 66 such that the lengthening of segment 78A and shortening of segment 78C corresponds to the raising of platform 20 and the reverse corresponds to the lowering of platform 20.

Right rear cable 68RR includes first, second, third and fourth segments 80A-D. Segment 80A is a horizontal longitudinal segment which extends forward from connector 70 to sheave S8 and around a portion of the circular outer perimeter thereof. Segment 80B is a horizontal longitudinal segment which extends from sheave S8 to sheave S9 and around portions of the circular outer perimeters thereof. Segment 80C is an axial horizontal segment which is adjacent and forward of rear crossbar 56R and extends from sheave S9 to sheave S10 and around respective portions of the circular outer perimeters thereof. Segment 80D is a vertical segment which extends around a portion of the circular outer perimeter of sheave S10 and upwardly therefrom to its connection with support 52 of assembly 22D. Vertical segment 80D is thus adjacent, to the left of and entirely external to the right rear post at 24 and the right rear slider 60.

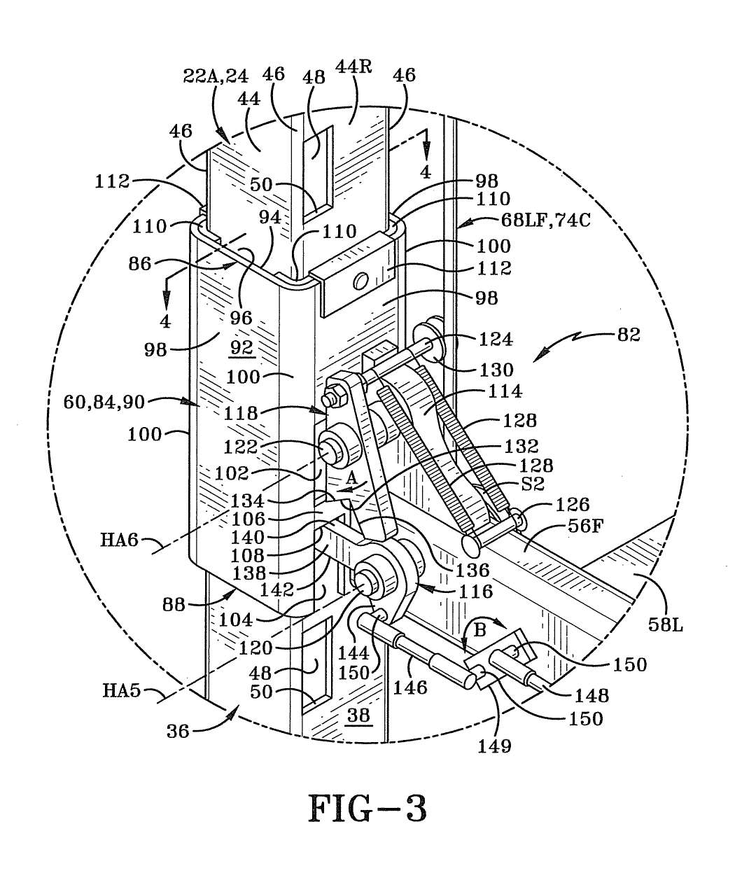

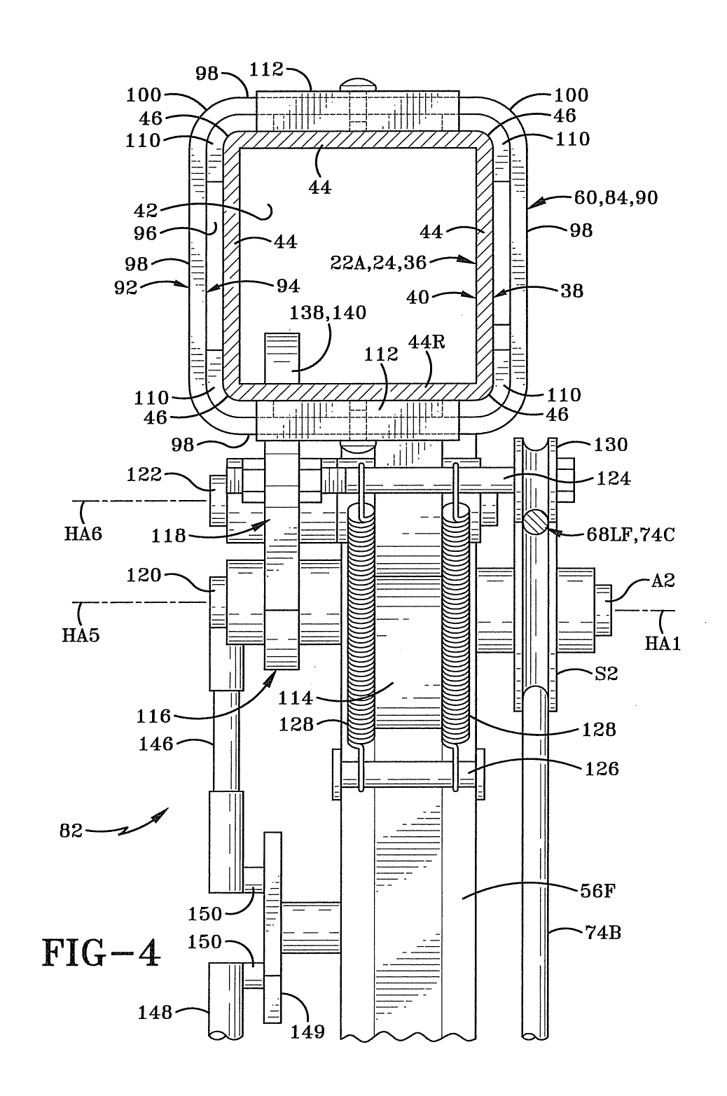

Lift 10 further includes a locking assembly which comprises four locking mechanisms 82 associated with each of post 24. Locking mechanism 82 will be described in greater detail after a more detailed description of slider 60 with primary reference to FIG. 3. Slider 60 includes a rigid collar or sleeve 84 which is formed of metal, typically steel, and has a top 86 and bottom 88. Sleeve 84 is a hollow structure formed of an annular sidewall 90 having a square cross-section (FIG. 4). Sidewall 90 has an outer surface 92 and inner surface 94 which defines an interior chamber 96 extending from top 86 to bottom 88. Sidewall 90 is formed of four flat vertical walls 98 which are respectively connected at four right angle corners 100. Post 24 is received within interior chamber 96 such that a portion of post 24 extends upwardly from a top entrance opening of interior chamber 96 and a portion of post 24 extends downwardly from a bottom entrance opening of interior chamber 96. Sleeve 84 is vertically slidable in a linear fashion up and down relative to post 24. An upper rectangular through opening 102 is formed through one of flat walls 98 adjacent one of corners 100 and extends from outer surface 92 to inner surface 94 so that opening 102 communicates with chamber 96 and space outside sleeve 84. A lower rectangular through opening 104 is similarly formed in the same side wall and spaced vertically downwardly from upper opening 102 such that lower opening 104 opens at a bottom entrance opening at bottom 88 of sleeve 84. The four corners 100 of sleeve 84 correspond to and are disposed adjacent and outwardly of corners 46 and post 24. Similarly, flat walls 98 correspond to and are spaced outwardly adjacent and parallel to flat walls 44 of post 24. Openings 102 and 104 are formed so that they are alignable with openings 48 in post 24 when positioned respectively at the same height of a given opening 48. Thus, the openings 102 and 104 of the left front and left rear sleeves 84 are formed in the right flat side wall 98 while the openings 102 and 104 in the right front and rear sleeves 84 are formed in the left flat walls 98 thereof. In the exemplary embodiment, a weight transferring portion 106 is disposed between the upper and lower openings 102 and 104 and includes a downwardly facing weight transferring ledge 108 for transferring the vast majority of the weight of the lift platform 20 and vehicle thereon to the respective posts 24.

Each slider 60 further includes four slide members 110 which are generally L-shaped as viewed from above and typically extend from adjacent top 86 to adjacent bottom 88 within interior chamber 96. Slide members 110 are formed of a relatively rigid material which is typically a plastic such as nylon or other suitable material which slides relatively easily along the metal outer surface of post 24 along corners 46. Slide members 110 thus avoid metal-to-metal contact between sleeve 60 and post 24. In the exemplary embodiment, slide members 110 are secured to sleeve 84 by a connecting bracket 112. Slide members 110 are thus rigidly secured to sleeve 84 with their respective outer surfaces abutting inner surface 94 along the inside of corners 100 respectively. The inner surfaces of slide members 110 thus slidably engage outer surface 38 of post 24 along corners 46 and portions of flat walls 44 adjacent said corners during the upward and downward sliding movement of lift platform 20. The use of external sliders 60 allows the post assemblies 22 to simply be seated on floor 30 without being rigidly secured to floor 30 such as with the use of fasteners as noted further above. Sliders 60 also provide a sliding connection with posts 24 which greatly minimizes the wobble experienced with prior art lifts when the posts of such lifts are not secured to a floor with fasteners.

Locking mechanism 82 is now described in greater detail with primary reference to FIGS. 3 and 4. Each end of each crossbar 56 is rigidly secured to sleeve 84 of slider 60 typically by welding. A generally triangular mounting flange 114 is also rigidly secured to the top of each crossbar 56 adjacent each end thereof and rigidly secured to the flat wall 98 in which openings 102 and 104 are formed to increase the strength of the connection between crossbar 56 and sleeve 84. Flange 114 serves as a mount for part of the corresponding locking mechanism 82. Locking mechanism 82 includes a primary locking member 116 and a secondary locking member 118 wherein primary locking member 116 is configured to secure platform 20 relative to posts 24 at a selected height under standard operating conditions whereas secondary locking member 118 is configured as a backup or emergency locking member which will secure platform 20 relative to posts 24 should one of the cables 68 break or otherwise become slack when primary locking member 116 is in a disengaged position such that the primary locking member 116 does not support the weight of platform 20 on the corresponding post 24. Each of locking members 116 and 118 in its engaged position prevents or secures lift platform 20 against downward movement relative to posts 24 and does not do so in its disengaged position. Primary locking member 116 is rotatably mounted on a longitudinal horizontal axle 120 to rotate about a longitudinally extending horizontal axis HA5 which in the exemplary embodiment is coaxial with axis HA1. Axle 120 may be the same as axle A2 about which sheave S2 is rotatably mounted. Axle 120 is secured to front axial crossbar 56F adjacent left end. Secondary locking member 118 is rotatably mounted on a longitudinally extending horizontal axle 122 about a longitudinally extending horizontal axis HA6 which is spaced upwardly of and parallel to axis HA5. Axle 122 is secured to mounting flange 114 and extends forward therefrom whereby secondary locking member 118 is adjacent and directly above primary locking member 116. An upper spring mount 124 is rigidly secured to an upper portion of secondary locking member 118 and in the exemplary embodiment is formed of a longitudinal horizontal rod which is threaded on one end and secured along its threaded portion with a pair of nuts respectively on opposed sides of locking member 118. The rod extends rearwardly from locking member 118. A lower spring mount 126 is rigidly secured to the top of crossbar 56F adjacent mount 114.

A pair of coil springs 128 extend from upper spring mount 124 to lower spring mount 126 with the upper ends of springs 128 connected to upper mount 124 and the lower ends of the springs connected to lower mount 126. FIG. 3 shows secondary locking member 118 in a disengaged position so that springs 128 are elongated sufficiently to apply a downward and rightward force to upper spring mount 124 which biases secondary locking member 118 in the rotational direction about axis HA6 indicated by Arrow A. However, a sheave 130 is secured to the rear end of the rod of upper spring mount 124 and engages vertical segment 74C of cable 68LF which when taut holds secondary locking member 118 in the disengaged position of FIG. 3 against the spring bias of springs 128. An L-shaped notch 132 is formed in the lower portion of secondary locking member 118 and is more particularly defined by a downwardly facing surface 134 and a laterally facing surface 136 which faces toward the corresponding sleeve 60 and post 24 and away from the post and sleeve on the other side of the lift. Surface 134 serves as a primary weight transfer surface when the secondary locking member 118 is activated to its engaged position discussed further below. Each of surfaces 134 and 136 serve as stops, which will also be discussed further below.

Primary locking member 116 has a central portion which engages axle 120 and a weight bearing arm 138 which extends radially outwardly therefrom such that arm 138 is substantially horizontal in the engaged position of FIG. 3. Opposed surfaces 140 and 142 of arm 138 are substantially horizontal and serve respectively as the top and bottom surfaces of arm 138 in the engaged position. Secondary member 118 further includes a connector lobe 145 which extends radially outwardly from the central portion of member 118 in a direction different than the arm 138.

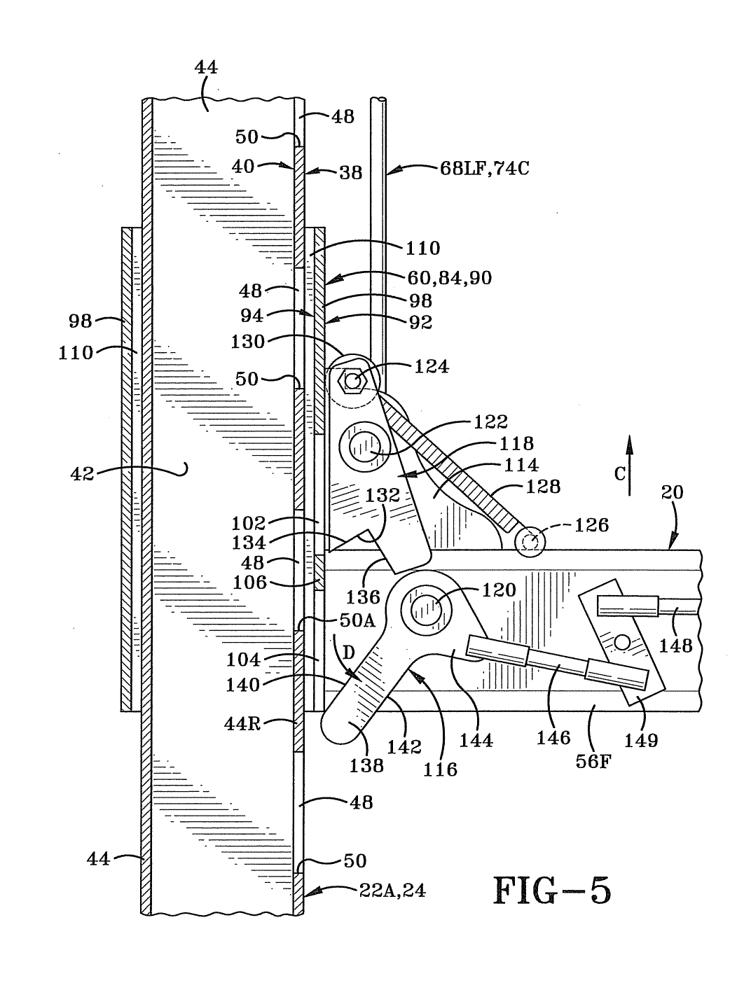

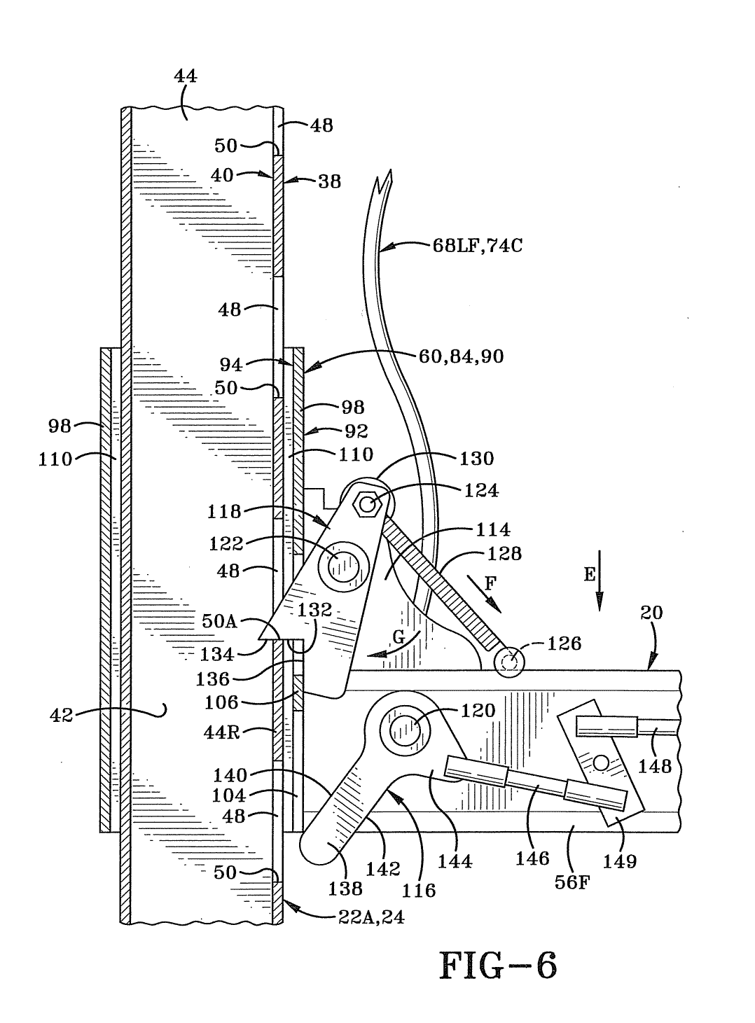

In keeping with the invention, many of the components which are adjacent the ends of crossbars 56, including many components of the locking mechanisms 82, are disposed entirely external to the corresponding post 24. For example, axle 120, axle 122, upper spring mount 124, lower spring mount 126, springs 128, sheave 130 and mounting bracket 114 are all entirely external to the post 24 adjacent which they are mounted and also entirely external to the sleeve 84 adjacent which they are mounted. In addition, primary locking member 116 in the engaged position shown in FIGS. 3 and 4 is partially external to the corresponding post 24 and sleeve 84 while a portion of arm 138 thereof is disposed within the interior chambers of the corresponding post 24 and sleeve 84 and within opening 104 and one of openings 48. However, arm 138 and thus primary member 116 is entirely external to the associated post 24 when member 116 is in its unlocked or disengaged position shown in FIGS. 5 and 6. Secondary locking member or stop 118 is entirely external to the corresponding post 24 and sleeve 84 when member 118 is in its disengaged position shown in FIGS. 3-5. When member 118 is in its engaged position shown in FIG. 6, a portion of member 118 is disposed within the respective interior chambers of the associated post 24 and sleeve 84 while a portion of locking member 118 remains external to the corresponding post and sleeve.

A primary locking member actuator assembly includes a variety of links for simultaneously moving the four primary locking members 116 of the various locking mechanisms 82 between engaged and disengaged positions. For example, this actuator includes adjacent each of the front and rear crossbars 56, a shorter link 146, a longer link 148 and a relatively short drive link 149 such that shorter link 146 is pivotally connected to lobe 144 and drive link 149 and respective pivots 150, and longer link 148 is pivotally connected to drive link 149 at another pivot 150 and to a corresponding lobe of the primary locking member 116 on the opposite side of the lift, as shown in FIG. 1 along the front end of lift 10. Although not all the components may be seen in FIG. 1 along the rear end of lift 10, FIG. 1 does illustrate one of the longer links 148 and also shows an actuating handle 152 which is manually movable to rotate the corresponding drive link 149 along the rear end of the lift and the link 149 along the front end to rotate as indicated at Arrows B in FIG. 3 to drive the movement the primary locking members 116 via the corresponding links 146 and 148 between the engaged and disengaged positions of the primary locking members. Like the various components of locking mechanism 82 which are at all times external to the corresponding post 24, the links of the primary locking member actuator assembly are also external to said posts at all times. Thus, the link 146 and pivot 150 which directly connects the link 146 to the primary locking member 116, is entirely external to post 24 and sleeve 84 at all times, as are the remaining links. Thus, for example, the longer link 148 and pivot 150 which directly connects link 148 to the right front primary locking member 116 (FIG. 1) are entirely external to the right front post 24 and corresponding right front sleeve 84.

The operation of the secondary locking member 118 is illustrated in FIGS. 5 and 6. More particularly, FIG. 5 illustrates that platform 20 has been moved upwardly (arrow C) so that primary locking member 116 can be rotated (arrow D) about axle 120 so that arm 138 is removed from one of openings 48 whereby primary locking member 116 is in its disengaged position external to openings 48 and 104 and does not support the weight of platform 20 and any motor vehicle seated thereon. Likewise, secondary locking member is also in its disengaged position external to openings 48 and 102 and does not support the weight of platform 20 and any motor vehicle seated thereon. Thus, platform 20 and any vehicle seated thereon is entirely supported by the taut cables 68 so that the vertical cable segments such as segment 74C engage the corresponding sheave 130 in order to overcome the spring bias of springs 128 and thus hold secondary locking member 118 in the disengaged position of FIG. 5. FIG. 6 illustrates the operation of secondary locking member 118 when a cable 68 breaks or the cable connections break such that the platform 20 falls (arrow E), the slack cable no longer presses against sheave 130 to overcome the spring bias of springs 128, which thus contract such that the upper ends of springs 128, the upper spring mount 126 and the upper portion of locking member 118 are pulled toward the lower ends of the springs and lower spring mount 126 (arrow F) to rotate locking member 118 (arrow G) about axle 122 to the engaged position. During the rotation of secondary locking member 118 from its disengaged position (FIG. 5) external to openings 102 and 48 to its engaged position (FIG. 6) within openings 102 and 48, surface 136 moves from a position out of contact with outer surface 92 of sleeve 84 into engagement with surface 92, which serves as a stop to the rotational movement. The rotational movement of member 118 also serves to insert a portion of locking member 118 through opening 102 of sleeve 84 and through one of openings 48 as platform 20 is falling so that surface 134 catches on the ledge associated with said opening 48, the support ledge indicated here at 50A. The engagement between surface 134 and support ledge 50A stops the falling of platform 20. Thus, a portion of the weight of platform 20 and any vehicle thereon is transferred to the corresponding post via the engagement between surface 134 and ledge 50A.

Lift 10 thus provides a lift with a cable system for raising and lowering the lift platform thereof while providing primary and secondary locking members or safety stops so that the locking mechanisms associated with the locking members are more accessible for repair and inspection. In addition, lift 10 provides smoothly operating sliders external to the corresponding posts whereby the structure of each post assembly is simplified, strengthened and easier to assemble.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A lift comprising:
a first post having an outer surface;
a second post;
a lift platform mounted on and movable upwardly and downwardly relative to the posts and adapted to carry a motor vehicle thereon; the lift platform comprising first and second sliders mounted respectively on the first and second posts;
a cable assembly which facilitates raising the lift platform; and
an engagement between the first slider and the outer surface of the first post during upward and downward movement of the lift platform.

2. The lift of claim 1 wherein the first slider is entirely external to the first post.

3. The lift of claim 1 wherein the first slider comprises an annular sidewall defining an interior chamber in which the first post is received.

4. The lift of claim 3 wherein the first slider comprises a plastic slide member within the interior chamber; and the engagement is between the slide member and the outer surface of the first post.

5. The lift of claim 1 wherein the first slider comprises a plastic slide member; and
the engagement is between the slide member and the outer surface of the first post.

6. The lift of claim 1 wherein the lift platform is entirely external to the posts.

7. The lift of claim 1 wherein the lift platform comprises a pair of runways and a pair of crossbars secured to the runways; and the crossbars are entirely external to the posts.

8. The lift of claim 1 wherein the cable assembly comprises a cable having a vertical segment which is adjacent and entirely external to the first post.

9. The lift of claim 8 further comprising a sheave which is entirely external to the first post and which engages the cable so that the vertical cable segment extends from the sheave.

10. The lift of claim 1 further comprising
a cable support secured to and extending laterally outwardly from the first post; and
a cable of the cable assembly which is secured to the cable support.

11. The lift of claim 1 wherein the cable assembly comprises a plurality of cables which are entirely external to the posts.

12. The lift of claim 1 further comprising
a through opening formed in the first post;
a through opening formed in the first slider;
a locking member within the through openings to secure the first slider against downward movement.

13. The lift of claim 1 further comprising a locking member which is mounted adjacent the first post, which is movable between an engaged position in which the locking member supports the lift platform on the first post and a disengaged position in which the locking member does not support the lift platform on the first post; wherein the locking member is entirely external to the first post in the disengaged position.

14. The lift of claim 13 further comprising a cable of the cable assembly which when taut prevents the locking member from moving from the disengaged position to the engaged position and which when slack allows the locking member to move from the disengaged position to the engaged position.

15. The lift of claim 1 further comprising
a cable of the cable assembly;
a locking member which is movable between an engaged position in which the locking member supports the lift platform on the first post and a disengaged position in which the locking member does not support the lift platform on the first post; and
a slack cable sheave which is engaged by the cable when the cable is taut to prevent the locking member from moving from the disengaged position to the engaged position and which moves from the disengaged position to the engaged position when the cable is slack; wherein the slack cable sheave is entirely external to the first post.

16. The lift of claim 1 wherein the first post has a top and a bottom and comprises an annular sidewall which extends from adjacent the top to adjacent the bottom, which defines the outer surface, which has an inner surface, and which is free of a vertical opening extending from the inner surface to the outer surface and from adjacent the top to adjacent the bottom.

17. The lift of claim 1 wherein the first and second posts are respectively part of first and second post assemblies each having a bottom adapted to sit on a substantially horizontal surface; and the lift is free of fasteners extending from adjacent the bottoms downwardly lower than the bottoms.

18. The lift of claim 1 wherein the lift is mountable on a substantially horizontal upper surface of a floor without fasteners extending from the lift downwardly below the upper surface of the floor.

19. A lift comprising:
a first post;
a second post;
a lift platform mounted on and movable upwardly and downwardly relative to the posts and adapted to carry a motor vehicle thereon;
a cable assembly which facilitates raising the lift platform; and
a first cable of the cable assembly having a vertical segment adjacent and entirely external to the first post.

20. A lift comprising:
a first post;
a second post;
a lift platform mounted on and movable upwardly and downwardly relative to the posts and adapted to carry a motor vehicle thereon;
a cable assembly which facilitates raising the lift platform; and
a locking member mounted adjacent the first post and movable between an engaged position in which the locking member supports the lift platform on the first post and a disengaged position in which the locking member does not support the lift platform on the first post; wherein the locking member is entirely external to the first post in the disengaged position.
